(19) United States
(12) Patent Application Publication
(10) Pub. No.: US 2019/0116038 A1
(43) Pub. Date: Apr. 18, 2019

(54) Attestation With Embedded Encryption Keys

(71) Applicant: Rivetz Corp., Wilmington, DE (US)

(72) Inventor: Steven Sprague, Richmond, MA (US)

(21) Appl. No.: 16/158,067

(22) Filed: Oct. 11, 2018

Related U.S. Application Data
(60) Provisional application No. 62/571,527, filed on Oct. 12, 2017.

(51) Int. Cl. H04L 9/32; H04L 9/06; G06F 21/57; H04L 9/08; H04L 9/14; G06Q 20/40

(52) U.S. Cl. CPC H04L 9/3213; H04L 9/3242; H04L 9/0637; G06F 21/572; H04L 9/3226; G06Q 2220/00; H04L 9/14; G06Q 20/401; H04L 2209/38; G06F 2221/032; H04L 9/085

(57) ABSTRACT

Embodiments are directed to computer-implemented methods and systems that provide assurance that cybersecurity controls for health and integrity of a device were in place at the time of a service transaction. The methods and systems generate a reference health hash representing initial state of security controls on a device, which is recorded at a network of a trusted service provider using a security token (e.g., RvT token). In embodiments, the trusted service provides is a Blockchain service and the device is configured with a trusted execution environment (TEE). In response to a service transaction, the methods and systems verify current security controls on the device based on generating and comparing a real-time health hash to the recorded reference health hash using the security token. The methods and systems record the results of the verification of the service transaction at the network of the trusted service provider. In response to a device audit, the methods and systems prove the state of the security controls on the device during the service transaction based on the recorded verification results and the recorded reference health hash.

### RELATED APPLICATIONS

This application claims the benefit of U.S. Provisional Application No. 62/571,527 filed on Oct. 12, 2017. This application is related to U.S. application Ser. No. 15/074,784, filed Mar. 18, 2016, which claims the benefit of U.S. Provisional Application No. 62/136,340 filed on Mar. 20, 2015 and U.S. Provisional Application No. 62/136,385 filed on Mar. 20, 2015. This application is also related to U.S. patent application Ser. No. 15/910,763 filed on Mar. 2, 2018, which claims the benefit of U.S. Provisional Application No. 62/467,678 filed on Mar. 6, 2017. The entire teachings of the above applications are incorporated herein by reference.

### BACKGROUND

Information assurance, or confirmation that information on a device has not changed, is one of the biggest challenges in modern computer science. The nature of the network, common access, and the use of web-based services have evolved rapidly over the last 10 years. However, cybersecurity protections have struggled to keep up with these evolutions. With rapidly evolving computer and mobile systems, the old models of software only cybersecurity is always one step behind the bad guys (e.g., hackers).

Prior cybersecurity solutions, including antivirus solutions, built for enterprises and personal computer networks cannot address the rapidly growing mobile and Internet of Things (IoT) device markets. Some of the challenges with the prior solutions are as follows. First, legacy cybersecurity systems developed for desktop personal computers (PCs) and in-house networks were not designed for a real-time, mobile device-driven world where sensitive information flows across public network systems to largely unknown devices outside the conventional network boundaries of enterprises, organizations, and government agencies. Second, cybersecurity and privacy within a device are often at odds in providing prior cybersecurity solutions. Third, cybersecurity has failed to keep pace with evolving threats caused by the increasing use of mobile devices, blockchains, smart contracts, IoT, and cloud computing. Fourth, blockchains, smart contracts, and the like require a new model for cybersecurity to protect private keys and instructions. Fifth, software-based security models focused on monitoring and detecting cyber-attacks have added complexity, frustrating users, while failing to prevent the cyber-attacks. Cyber-attacks have been pervasive and have diminished the value and quality of services that could otherwise be delivered, thus, hindering growth in the digital services market and limiting the value of subscribers to service providers.

Another growing challenge in cybersecurity is compliance to new regulations. For example, the European Union GDPR (“General Data Protection Regulation”) can fine companies up to 4% of their gross revenue for a data breach. The GDPR goes into effect on May 25, 2018, giving businesses around the world a chance to prepare for compliance, review data protection language in contracts, consider transitioning to global standards compliant with GDPR, update their privacy policies, and review marketing plans, which are efforts that will continue long after the GDPR effective date. The reach of California's data protection law, SB1386, has been extended such that it is not only important to prove that encryption was enabled on a lost device but also that the device's credential systems have not been compromised.

### SUMMARY

Embodiments of the present invention augment the attestation systems, methods, and protocols disclosed in U.S. patent application Ser. No. 15/074,784 and U.S. patent application Ser. No. 15/910,763, herein incorporated by reference in their entirety, to address the above-mentioned issues with prior cybersecurity solutions. These embodiments augment those attestation systems/methods/protocols by providing a global attestation and identity network (GAIN) that provides assurance that cybersecurity controls for health and integrity of a device were in place at the time of a service transaction. Such devices may include personal computers (PCs), mobile devices, IoT devices, and the like. The GAIN utilizes an encryption key and/or security token (e.g., Rivetz token or RvT) configured on the device, which enables trusted recording of the initial cybersecurity control states of the device at a secure location (blockchain, database, or such) on the GAIN as a reference health measurement. The GAIN further enables continuously (in real-time) measuring, testing, and validating the cybersecurity control states of the device at the time of a service transaction against the reference health measurement.

To do so, these embodiments calculate a hash representing the real-time cybersecurity control states of the device at the time of the service transaction, which is compared to the recorded reference health measurement (also calculated as a hash) to determine a change in the cybersecurity control states. In this way, the service provider associated with the transaction can be assured of the device's cybersecurity control of health and integrity when performing the service transaction. These embodiments further utilize the security token to enable trusted recording of the cybersecurity controls state of health and integrity of the device at the secure location on the GAIN at the time of the service transactions, such that the health and integrity of the device during the service transaction cannot be later misrepresented. The recorded (provable and trusted) cybersecurity control state at the time of a service transaction may be reported in response to a compliance request (audit) of the device.

Example embodiments of the present invention are directed to a computer-implemented methods and computer systems for verifying security controls of a device. The methods and systems generate (e.g., via a cybercontrol marketplace engine) a reference health measurement representing initial state of security controls on a device. In some embodiments, the methods and systems generate the reference health measurement based on initial internal security controls, initial external security controls, and trusted manufacturer signatures associated with the trusted execution environment (TEE) configured on the device. The methods and systems record the reference health measurement at a network of a trusted (secure) service provider using a security token. In some embodiments, the trusted service provider uses at least one of: a blockchain, a smart contract, and fintech. The methods and systems, in response to a service transaction, verifies (e.g., via a cybersecurity controller) current security controls on the device based on the recorded reference health measurement using the security token. The methods and systems record results of the verification for the service transaction at the network of the trusted service provider. The methods and systems, in response to a device audit, proves (e.g., via the cybercontrol marketplace engine) the state of the security controls on the device during the service transaction based on the recorded verification results and the recorded reference health measurement.

In some embodiments, the methods and systems generate (e.g., via the cybercontrol marketplace engine in communication with the device) the reference health measurement as follows. The method verifies the trusted manufacture signatures and calculates: (i) a hash for the initial internal security controls and (ii) a hash for the initial external security controls. The methods and systems combine the initial internal security controls hash and the initial external security controls hash into a reference health hash representing the reference health measurement of the device. The methods and systems then, using the security token, seal and record the combined reference health hash at the trusted service provider network. The methods and systems record the location (in the trusted service provider network) of the recorded reference health hash at the device.

In some embodiments, the methods and systems verify the current security controls on the device as follows. The methods and systems, in response to a user initiating the service transaction, create a transaction identifier (ID) for the service transaction. The methods and systems (e.g., via the cybercontrol marketplace engine in communications with the device) next perform: (a) a real-time test of the internal security controls, resulting in a real-time internal controls hash, and (b) a real-time test of the external security controls, resulting in a real-time external controls hash. The methods and systems then combines the real-time internal security controls hash and real-time external security controls hash into a real-time health hash. The methods and systems, using the recorded location and the security token, retrieves the recorded reference health measurement hash from the trusted service provider network, wherein verifying (e.g., via the cybersecurity controller) whether the recorded reference health hash matches the real-time health hash. The methods and systems record the results of the verification, the real-time health hash, and the transaction identifier as an event at the network of the trusted service provider.

In some embodiments, the methods and systems (e.g., via the cybercontrol marketplace engine in communication with the device) prove state of the security controls as follows. The methods and systems retrieve the recorded event from the trusted service provider network using the transaction identifier. The methods and systems also retrieve the recorded reference health hash from the trusted service provider network using the recorded location and the security token. The methods and systems determine an internal security controls hash and an external security controls hash from the real-time health hash in the recorded event. The methods and systems then verifies that: (a) the determined internal security control hash matches the initial internal security controls hash, and (b) the determined external security control hash matches the initial external security controls hash based on the reference health hash. The methods and systems generate a report proving the verification of security controls of the device during the service transaction.

Embodiments further augment the attestation methods, systems, and protocols with the secure release of an encryption key that enables accessing data on a server only when a requesting device is in a measured reference condition. The requesting device provides identity and real-time attestation data. The server submits this data to a secure verifier, either locally or remotely, which is either in the operating system (OS), in a hardware security module (HSM), a smart contract, or a remote secure process associated with the device. The verifier looks-up a reference measurement of the requesting device in a block chain, database, or the like and retrieves the reference measurement, along with encryption keys. The process of verification of the real-time measurement, combined with identity and key information from the requesting system, to the reference measurement produces a decryption key if the reference measurement is equal to the real-time data. This encryption key is used by the server to fetch secure data. The encryption key can be delivered to software on the server, an HSM, a local smart contract, or another secure process associated with the device.

Previous embodiments of attestation do not include the use of an encryption key to unlock server data and protect that critical data from the operator of the server. The methods and systems also assure that only compliant systems can be connected to sensitive data preventing data leakage from distributed systems that have no central controls. The goal is that data is computed for a known device only when it is connected or recently connected.

In embodiments, the service transaction is a financial transaction, and the methods and systems apply compliance policies locally, including encrypting, signing, and recording receipts of the service transaction, at the device to partially control the financial transaction at the device prior to the submission of the financial transaction to a transaction processing system. In some embodiments, the methods and systems perform a BIOS integrity control test as part of verifying current security controls. The BIOS integrity control test produces a BIOS integrity token for the device, which is asserted to third party services to assure BIOS integrity test were completed on devices executing the third-party services.

In embodiments, the methods and systems further perform bidirectional attestation of the health and integrity of the device and a service provider server as follows. The methods and systems provide by the device to a smart contract a first set of data including: device identity, a real-time hash message address, and a reference hash locator. The methods and systems also provide by the server to the smart contract a second set of data including: an identity real-time hash message address and reference hash locator. The smart contract is hosted on a distribute app model using the blockchain and accessed by an untrusted agent on a cloud server. The methods and systems activate the smart contract with the first and second sets of data and an access control challenge token, and sends messages to both the device and the server. Using the reference hash locators, the methods and systems retrieve references hashes for the client device and the server. The methods and systems compare, by the smart contract, the real-time hashes and returns in respond to the sent messages and reference hashes for the client device and the server. If the hashes match, the smart contract responds with the correct response to the control challenge, thereby granting access to the service transaction.

In embodiments, the methods and systems performs verification that the device meeting the recorded reference health measurement. In these embodiments, the methods and systems only enable generation of a multi-factor passcode to perform transactions from the device if the verification is successful. In embodiments, the methods and systems provide multi-factor authentication (MFA) as follows. The methods and systems generate, by the device, a nonce that is sent to a paired data provider enabled to share authentication keys with the device. In response the data provider, the methods and systems then perform an authentication function and returning the data results to the device using the nonce. Using the data results, the methods and systems calculate the shared authentication keys for the paired device and data provider to provide a second authentication factor for the pairing. In embodiments, the TEE configured on the device uses MFA and logs the device's MFA as a provable time stamped event in the blockchain, such that if use of the security token associated with the MFA is detected in unrelated systems, the TEE notifies the user of the use and locks the device.

In embodiments, the methods and system, by the TEE on the device, measures and logs use of authentication keys at the device, and sends the logs to a central service for recording and accessing. The methods and systems blocks use of the authentication keys at the device until at least one of: the authentication keys are logged at the central service, the logged use is confirmed internally by the TEE, and the use is during specific times of day. Embodiments further comprise the methods and systems communicating with a central service that administers a policy system that controls authentication keys and services on the device. The central service controls and logs changes in policies for an authentication key or service of the device.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is an example digital processing environment in which embodiments of the present invention may be implemented.

FIG. 1B is a block diagram of any internal structure of a computer/computing node.

FIG. 2A illustrates an example system for registering health of a device in an embodiment of the present invention.

FIG. 2B illustrates an example system for verifying cybersecurity controls in an embodiment of the present invention.

FIG. 2C illustrates an example system for attesting health of a device in an embodiment of the present invention.

FIGS. 3A-3B are example methods of attesting health of a device in embodiments of the present invention.

FIG. 4 is an example system of providing encryption keys based on attesting the health of a device in embodiments of the present invention.

FIG. 5A is an example system for logging authentication key use in embodiments of the present invention.

FIG. 5B is an example system for providing centralized control of device authentication keys in embodiments of the present invention.

FIG. 6 is an example system for performing bidirectional attestation in embodiments of the present invention.

FIG. 7 is an example system for performing multi-factor authentication in embodiments of the present invention.

### DETAILED DESCRIPTION OF THE INVENTION

A description of example embodiments of the invention follows.

Embodiments of the present invention are systems and methods for attesting and recording security controls of health and integrity for a computing device. These embodiments augment the attestation systems, methods, and protocols disclosed in U.S. patent application Ser. No. 15/074,784 and U.S. patent application Ser. No. 15/910,763, herein incorporated by reference in their entirety. Some of these embodiments are further described in the White Paper, “Cybersecurity for Decentralized Systems,” version 1.01, June 2017, herein incorporated by reference in its entirety.

### Digital Processing Environment

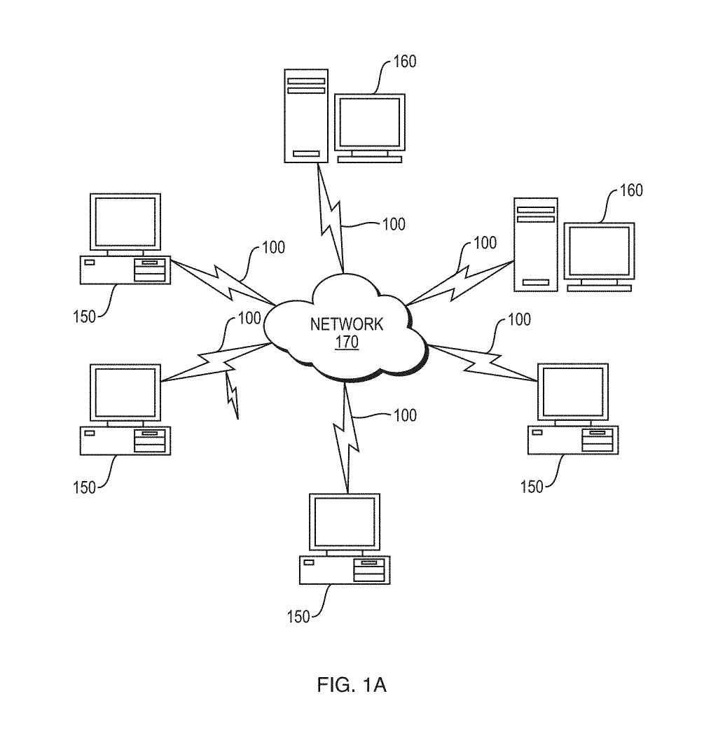

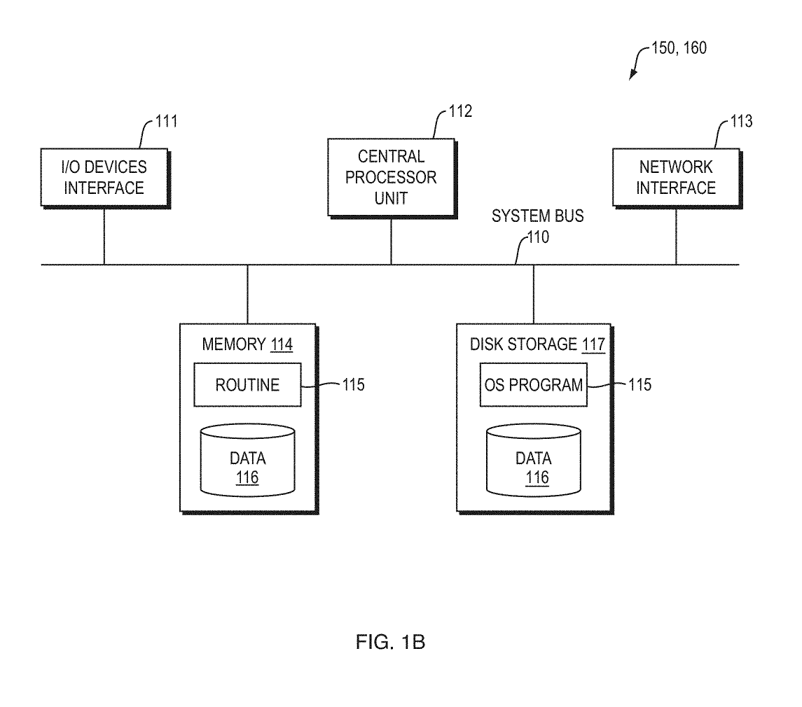

An example implementation of a device authentication system 100 according to an embodiment of the invention for attesting to device health prior to engaging in transactions or for compliance audits may be implemented in a software, firmware, or hardware environment. FIG. 1A illustrates one such example digital processing environment in which embodiments of the present invention may be implemented. Client computers/devices 150 and server computers/devices 160 provide processing, storage, and input/output devices executing application programs and the like.

Client computers/devices 150 may be linked 100 directly or through communications network 170 to other computing devices, including other client computers/devices 150 and server computer/devices 160. The communication network 170 can be part of a wireless or wired network, remote access network, a global network (i.e. Internet), a worldwide collection of computers, local area or wide area networks, and gateways, routers, and switches that currently use a variety of protocols (e.g. TCP/IP, Bluetooth®, RTM, etc.) to communicate with one another. The communication network 170 may also be a virtual private network (VPN) or an out-of-band network or both. The communication network 170 may take a variety of forms, including, but not limited to, a data network, voice network (e.g. land-line, mobile, etc.), audio network, video network, satellite network, radio network, and pager network. Other electronic device/computer networks architectures are also suitable.

Server computers 160 may be configured to provide a device authentication system 100 which verifies, records, and retrieves the cybercontrol states (e.g., health and integrity) of the user device at the time of a service transaction. The server computers 160 may not be separate server computers but part of a cloud service.

FIG. 1B is a block diagram of any internal structure of a computer/computing node (e.g., client processor/device 150 or server computers 160) in the processing environment of FIG. 1A, which may be used to facilitate displaying audio, image, video or data signal information. Each computer 150, 160 in FIG. 1B contains a system bus 110, where a bus is a set of actual or virtual hardware lines used for data transfer among the components of a computer or processing system. The system bus 110 is essentially a shared conduit that connects different elements of a computer system (e.g., processor, disk storage, memory, input/output ports, etc.) that enables the transfer of data between elements.

Attached to the system bus 110 is an I/O device interface 111 for connecting various input and output devices (e.g., keyboard, mouse, touch screen interface, displays, printers, speakers, audio inputs and outputs, video inputs and outputs, microphone jacks, etc.) to the computer 150, 160. A network interface 113 allows the computer to connect to various other devices attached to a network (for example the network illustrated at 170 of FIG. 1A). Memory 114 provides volatile storage for computer software instructions 115 and data 116 used to implement software implementations of device integrity attestation and authentication components of some embodiments of the present invention. Such device integrity attestation and authentication software components 115, 116 of the device authentication system 100 (e.g. encoder, Trusted Execution Environment (TEE) applet, authentication site, cybersecurity controller, service applications, and the like) described herein may be configured using any programming language, including any high-level, object-oriented programming language, such as Python.

In an example mobile implementation, a mobile agent implementation of the invention may be provided. A client server environment can be used to enable mobile security services using the server 160. It can use, for example, the XMPP protocol to tether a device authentication engine/agent 115 on the device 150 to a server 160. The server 160 can then issue commands to the mobile phone on request. The mobile user interface framework to access certain components of the system 100 may be based on XHP, Javelin and WURFL. In another example mobile implementation for OS X and iOS operating systems and their respective APIs, Cocoa and Cocoa Touch may be used to implement the client-side components 115 using Objective-C or any other high-level programming language that adds Smalltalk-style messaging to the C programming language.

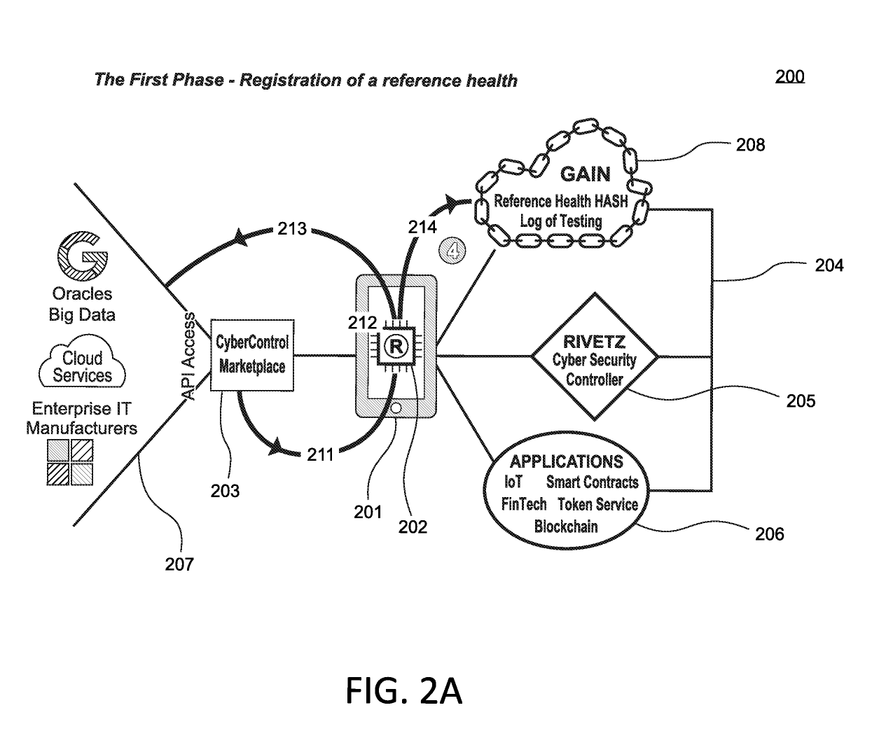

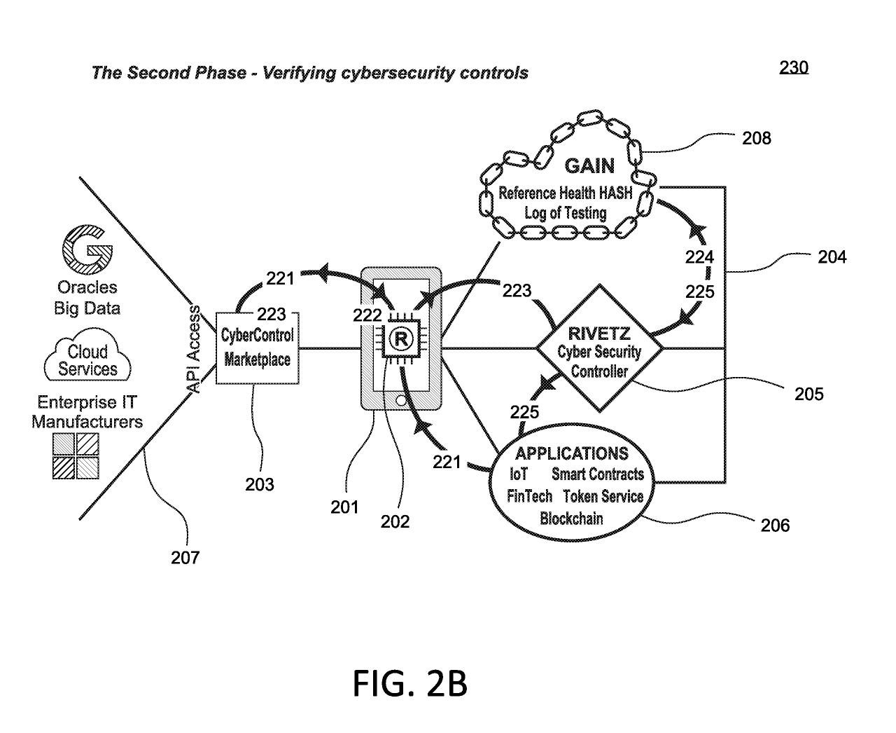

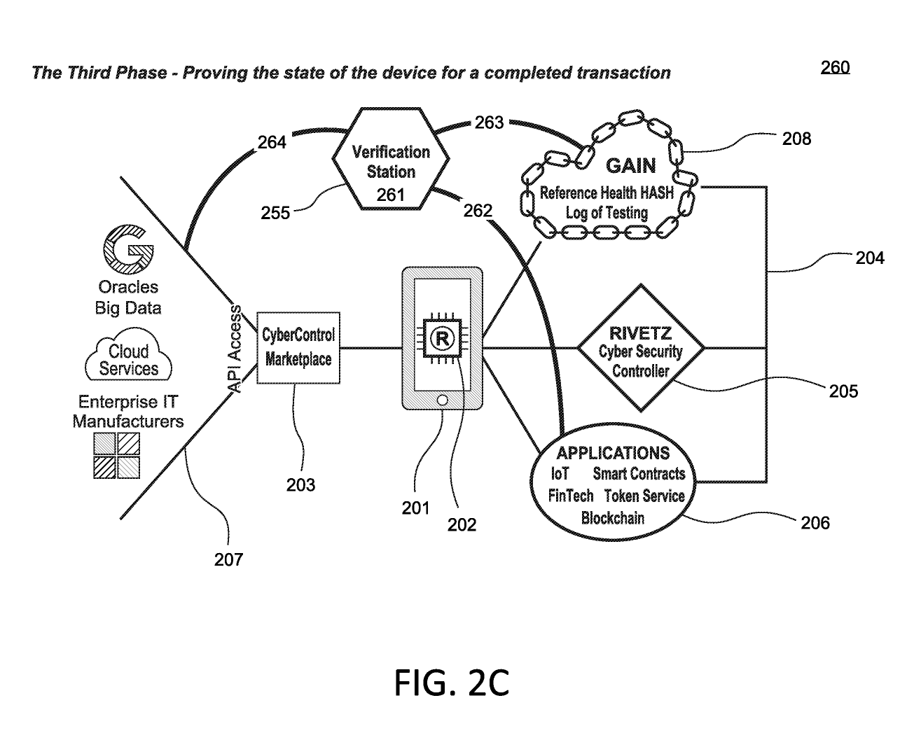

The system may also include instances of server processes on the server computers 160 that may comprise a cybercontrol marketplace engine or server (as shown in FIGS. 2A-2C), which allow validating the initial state of device cybersecurity controls on health and safety, computing a reference health measurement hash representing the initial device cybersecurity controls, and checking state of cybersecurity controls at the time of a service transaction against the reference health measurement hash to prove regulatory compliance or allow a current service transaction. The server computer 160 may also comprise a cybersecurity controller or server (as shown in FIGS. 2A-2C) which, using a security token (RvT token) and/or encryption keys, verifies results of real-time cybersecurity control tests at the time of a service transaction and records the test results (and identifier for the service transaction) to a trusted service provider on the GAIN. The system may also include instances of client processes on the client computers 150 that may comprise user devices (as shown in FIGS. 2A-2C) configured with a TEE and having internal and external cybersecurity controls of health and integrity. The user devices, using the security token and/or encryption key, may calculate their internal cybersecurity controls, record the reference health measurement hash calculated by the cybercontrol marketplace engine to the GAIN, initial service application to perform a service transaction, and execute real-time tests to determine state of cybersecurity controls at the time of a transaction.

Disk storage 117 provides non-volatile storage for computer software instructions 115 (equivalently “OS program”) and data 116 used to implement embodiments of the system 100. The system may include disk storage accessible to the server computer 160. The server computer can maintain secure access to records related to the authentication of users registered with the system 100. Central processor unit 112 is also attached to the system bus 110 and provides for the execution of computer instructions.

In an example embodiment, the processor routines 115 and data 116 are computer program products. For example, if aspects of the device authentication system 100 may include both server side and client-side components.

In an example embodiment, authenticators/attesters may be contacted via instant messaging applications, video conferencing systems, VOIP systems, email systems, etc., all of which may be implemented, at least in part, in software 115, 116. In another example embodiment, the authentication engine/agent may be implemented as an application program interface (API), executable software component, or integrated component of the OS configured to authenticate users on a Trusted Platform Module (TPM) executing on a computing device 150.

Software implementations 115, 116 may be implemented as a computer readable medium capable of being stored on a storage device 117, which provides at least a portion of the software instructions for the device authentication system 100. Executing instances of respective software components of the device authentication system 100, such as instances of the cybercontrol marketplace engine or cybersecurity controller of FIGS. 2A-2C, may be implemented as computer program products 115, and can be installed by any suitable software installation procedure, as is well known in the art. In another embodiment, at least a portion of the system software instructions 115 may be downloaded over a cable, communication and/or wireless connection via, for example, a browser SSL session or through an app (whether executed from a mobile or other computing device). In other embodiments, the system 100 software components 115, may be implemented as a computer program propagated signal product embodied on a propagated signal on a propagation medium (e.g. a radio wave, an infrared wave, a laser wave, a sound wave, or an electrical wave propagated over a global network such as the Internet, or other networks. Such carrier medium or signal provides at least a portion of the software instructions for the present methods/systems 200, 230, 260, 300, 350, 400, 500, 550, 600, and 700 of FIGS. 2A-2C, 3A-3B, 4, 5A-5B, 6, and 7.

Certain example embodiments of the invention are based on the premise that online services may be significantly enhanced when a device can be trusted to its said health and integrity and to execute instructions exactly as requested. A service provider generally has confidence in its servers because they are under administrative control and usually protected physically. However, nearly all of the service provider's services are delivered to users through devices the service provider knows very little about and over which it rarely exerts any control.

Through the use of Trusted Execution technology, certain inventive embodiments are able to provide a service provider with an oasis of trust in the unknown world of consumer devices. Basic capabilities such as “sign this”, or “decrypt this” are executed outside the murky world of the main OS. Keys can be generated and applied and policies can be applied to the keys without ever being exposed in memory and can be attested to through a chain of endorsements traced back to the device manufacturer.

Certain aspects of the invention enable trust in devices and health and integrity of the devices. Some embodiments operate on the fundamental premise that a reliable relationship with a device can make for a much safer, easier and stronger relationship with an end user. Achieving this requires knowing with confidence that a device involved in a current transaction is the same healthy device it was in previous transactions. It also requires assurance that a device will not leak protected information if it is requested to perform sensitive operations, such as decryption or signing.

One example preferred embodiment includes device code executed in the Trusted Execution Environment (TEE). The TEE preferably is a hardware environment that runs small applets outside the main OS. This protects sensitive code and data from malware or snooping with purpose-built hardware governed by an ecosystem of endorsements, beginning with the device manufacturer.

### Global Attestation and Identity Network (GAIN) Overview

The revolution of the blockchain and the decentralization of device controls and keys combine to make a new infrastructure for trust built on calculations and signatures rather than human promises. Together these technologies provide the platform to enable a new paradigm for cybersecurity. A new security token, RvT token, is designed to explore the full value of the paradigm, in order to deliver not only the cybersecurity controls to assure a known device in a known condition with a known user producing or consuming provable data, but also to assure that the device can be trusted to follow the policies of the device owner and procure services automatically.

Embodiments of the present invention provide a global ecosystem of cybersecurity checkpoints empowered by a blockchain micro-transaction model. The decentralized network of cybersecurity checkpoints enforces the policies the owner of a TEE-enabled device specifies, assuring only known devices in a known condition are allowed to access and process sensitive information. The decentralized network of TEE-enabled devices supervises and enforces the owner's policies for utility service.

The decentralized systems or devices of the world need provable cybersecurity controls to assert that certain transaction data is real and reliable. The RvT security token of embodiments of the present invention provides operational security and enable the business model for integrity validation and attestation of transactions in real-time. The RvT token is a utility token used by the owner of a device and service providers to assert that a transaction was sent by a measured system or device in a reference condition. The use of an RvT token can be locked by a TEE-enforced policy on a device and can only be used according to the rules the owner sets, dramatically reducing the risk of theft or misuse of the token.

The RvT token is designed to integrate with the data structures and methods that are required by the Trusted Computing Group and Global Platform standards (for the TEE) to assure that devices have provable capabilities and controls. These technologies are standards-based, have been developed over the last 20 years, and have been shipping on new devices globally for over 10 years. The decentralized systems are based on hashes and digital signatures, but like any technology, have their unique models as well. Blockchain technology provides a great fit for these technologies and many of the blockchain capabilities have been fully integrated to simplify the level of resources required to support different trusted computing solutions. The trusted execution environment (TEE) provides isolated execution of code on the main processor of the device. When the TEE powered on, the code that is executed inside the TEE is signed and the signatures are verified before any code executes. Each step in embodiments of the present invention verify the signature of the next step before it runs. If it works, this chain of trust guarantees the “integrity” of the code is verified. With the last signature “the health” of the device can be checked by embodiments of the present invention to assure nothing has been changed on the device, and using microtransactions to assure only the policy services requested are settled by the RvT token.

### Global Attestation and Identity Network (GAIN) Architecture

The architecture (environment) of embodiments of the present invention is designed to deliver provable cyber-controls for the owner of devices ranging from PCs to smartphones to IoT devices. The environment operates on a decentralized trust model providing the proof the device owner needs without having to trust third-party services or sites to back the claims made by the device. The environment provides an embedded utility tokens (RvT tokens) to provide secure settlement for services from known provable service providers. Different devices have the potential for varying levels of assurance. The GAIN architecture is designed to flexibly adapt to these variances.

RvT tokens provide a new approach in the blockchain market being designed to assure attestation and policy are fully integrated into the blockchain process. The TEE embedded on a device provides the policy enforcement of the device to assure the security rules are followed. The processing of the RvT token is designed to verify the integrity of the TEE, assuring that the policy was in place on the device prior to a key being used or a transaction created. The RvT token provides a symbiotic linkage intended to embed the information necessary to prove that a known device in a known condition with a known user produced a provable instruction with strong privacy controls. A primary goal of the RvT token is that privacy of the device is protected and all device-controlled transactions only occur between parties known to the owner of the device. The identity information of the device is tokenized in order to seek to assure tracking of transactions on a chain is not bound to a specific service. However, the RvT token requires that all parties are identified to the owner of the device thereby reducing the risk that malware can extract value from the automated device and associated systems.

The TEE of the device provides the protected application of policy that governs the use of a security encryption key or a security token (e.g., RvT token). Once a security key/token is passed to the TEE protected private keys, it can only be transferred if the device owner's instructions meet policy. The owner of the device is the administrator of the policy controls in the TEE and defines the process the owner expects to be followed. To reduce the risk of compromised instructions, the process integrates an attestation test and prevents a transfer of key/token if the health defined by the policy is violated or its enforcement cannot be verified.

The device is provisioned with security keys/tokens (e.g., RvT tokens) and the owner of the device determines the policies (rules) that are in place and required on the device before the TEE can use any of those tokens. The TEE policy can be altered by the owner of the device locally or remotely at any time depending on the requirements for compliance. The TEE follows policy to transfer the keys/tokens, and such instruction includes a verification that the TEE is in a reference condition. This prevents any tokens from being transferred by the machine without the owner-approved policy being applied to the transfer.

The security key/token (e.g., RvT token) is intended to provide a device with a mechanism for obtaining decentralized services. Devices need such a strong mechanism for automated access and for a use-as-you-consume model for extremely small transactions. The key/token is designed to cooperate with the TEE to provide the security and transaction models required for decentralized services. History has shown that metering-based models are easily abused and fraud is hard to detect. To realize the incredible future of billions of devices, such as Internet of Things (IoT) devices, the Internet needs a mechanism for ensuring that devices can be trusted. The Global Attestation and Identify Network (GAIN) environment achieves the unique balance between privacy and security or control. The key/token (RvT token) enables a device to initiate automated microtransactions that are supervised and verified by the TEE and the cybersecurity checkpoint. The RvT token is designed to have multiple controls embedded by the owner, the device, and the checkpoint as part of the end-to-end recording of the settlement. These controls provide a foundation for a broad class of utility payments that devices might require from storage to processing to replacement. The attestation capabilities are a core building block to enable automated transactions.

FIG. 2A-2C illustrate the configured computing environment for the GAIN in example embodiments of the present invention. The computing environment includes a computing device 201 (e.g., mobile device, IoT, PC, and the like) configured with a Trusted Execution Environment 202 and a security encryption key or token (e.g., RvT token). The computing device 201 is also configured with applications 206 for accessing web-based services, such as smart contracts, fintech, token service, blockchain, and such that are communicatively coupled to the system environment. The computing device 201 is communicatively coupled over a computer network to a cybercontrol marketplace engine 203 (associated with one or more web-based service providers), which is communicatively coupled (through an API) to a network 207 of databases (big data), cloud services (enterprise IT), manufactures, and the like. The owner/user of the device 201 configures and selects the services that the owner/user wants the device 201 to verify in order to achieve the external cybersecurity reference controls for the device 201. These controls may vary from free components to connections to existing enterprise services, extensions to commercial products to verify controls or cloud service that could provide anything from time of day to location. The services and business models vary and the RvT token is one of the mechanisms for settlement.

The computing device 201 is also communicatively coupled to the global attestation and identify network (GAIN) 204. The device owner configures the device 201 to use a preferred service provider 208 (as the GAIN) to store and manage the reference health information for the cybersecurity controls. The preferred service provider 204 may be blockchain, smart contract, cloud computing, and such, without limitation. The computing device 201 is also communicatively coupled to a cybersecurity controller (server) 205 which may exist standalone or built-into other services or service networks. The cybersecurity controller 205 receives cybersecurity control information from the computing device 201. The cybersecurity controller 205, using the security key/toke (e.g., RvT token), may verify the health condition of the device 201 for performing a service transaction, generate an event containing the verified health condition of the device at the time of the service transaction (along with a transaction identifier and a real-time health condition hash in some embodiments), and records (logs) the generated event to a preferred service provider network 208 of the GAIN 204.

Some example embodiments of the GAIN environment are further described in the White Paper, “Cybersecurity for Decentralized Systems,” version 1.01, June 2017, herein incorporated by reference in its entirety.

FIGS. 2A-2C depict the use of the configured computing environment for the GAIN 204 in three phases. FIG. 2A is a system (and method) 200 that executes the first phase of registration of a reference health for the device 201. FIG. 2B is a system (and method) 230 that executes the second phase of verifying cybersecurity controls of the device 201 based on the registered reference health. FIG. 2C is a system (and method) 260 that executes a third phase of proving the state (cybersecurity controls) of the device 201 for a completed transaction. Other embodiments of the present invention may include a different number phases that perform the same or different functions, without limitation.

### Registering Health of a Device in GAIN

FIG. 2A illustrates a system (and method) 200 of registering a reference health of a device 201 in an embodiment of the present invention. The method 200, step 211, pairs the computing device 201 (configured with TEE) and the cybercontrol marketplace engine 203 (associated with one or more service providers 206). At step 212 of method 200, the device 201 calculates an internal health and integrity hash for the internal cybersecurity controls of the device 201 (e.g., in the TEE 202) and prepares to have the manufacturer core root of trust signatures for the device 201 verified by the cybercontrol marketplace engine 203. At step 213 of method 200, the cybercontrol marketplace engine 203 executes an owner-provided script to validate any external cybersecurity controls (e.g., enterprise or cloud controls) of the device 201. At step 213 of method 200, the cybercontrol marketplace engine 203 also verifies that the manufacturer core root of trust signatures are valid for use in internal device tests. Based on the validations, the cybercontrol marketplace engine 203 calculates and returns an external health hash to the device 201. A security token (e.g., RvT token) is used to obtain and perform operations related to the health and integrity hashes.

At step 214 of method 200, the device uses the security token configured on the device 201 to seal the combined internal and external health hash to generate a reference health measurement hash and record this reference health hash on the GAIN (e.g., a blockchain service provider network) 204 using a microtransaction. The reference health measurement hash represents the initial reference state of the cybersecurity controls associated with the device 201. Using the security token, the device 201 also records (registers) the location of the health hash (e.g., recorded on the GAIN 204) at the device 201 for later reference and use by the device 201.

In embodiments, the device 201 is configured (e.g., by the device owner) to use the preferred trusted service provider 208 (e.g., blockchain, smart contract, and the like) on the GAIN 204 to store and manage the reference health measurement hash and results from verification performed by the cybersecurity controller 205. Note in other embodiments, the device 201 may perform the verification instead of the cybersecurity controller 205. The system is built around a unique locator to enable any service provider that supports the protocols to offer a service, which are supported by the security token (e.g., RvT token).

In embodiments, the method 200 also performs a BIOS integrity control test that produces a token (e.g., the RvT token) for the device 201, which may be recorded at the device 201. In embodiments, the cybersecurity controller 205 may perform the BIOS integrity control test, and in other embodiments the device 210 performs the BIOS integrity control test. In embodiments, the device 201 is configured to use the preferred trusted service provider 208 on the GAIN 204 to store and manage the BIOS integrity token. The token can be asserted to third-party services (such as service applications 206) to assure the BIOS integrity test has been completed prior to engaging in a transaction with the device 201.

### Verifying Cybersecurity Controls In GAIN

FIG. 2B illustrates an example system (and method) 230 of verifying cybersecurity controls at the time of a service transaction in an embodiment of the present invention. At step 221 of method 230, a user (device owner), via a service application 206 configured on the device 201, selects a service transaction (e.g., via a service application on the device) that requires a health check. In response, the device 201, in communication with the cybercontrol marketplace engine 203, creates a unique transaction ID. At step 222 of method 230, the device 201, in communication with the cybercontrol marketplace engine 203, performs real-time tests of the internal cybercontrols of the device 201 to generate a real-time internal cybercontrol hash, and real-time tests of the external cybercontrols of the device to generate a real-time external cybercontrol hash. The real-time tests may be performed in the TEE 202 of the device 201. At step 222, the device 201, in communication with the cybercontrol marketplace engine 203, further combines the real-time internal cybercontrol hash and real-time external cybercontrol to generate a real-time health hash for the device 201. At step 223 of method 230, the device 201 seals the combined real-time health hash with the reference health hash locator using the security token configured at the device 201 (e.g., within the TEE 202). The device 201 transmits a request containing the sealed combined real-time health hash to the cybersecurity controller 205 for verification. At step 224 of method 230, using the security token, the cybersecurity controller 205 retrieves the reference health hash (from the location saved in method 200) and compares it to the real-time health hash contained in the request. If the two hashes match, the method 230 verifies that the device 201 is in a reference condition (and may allow the service transaction to proceed). At step 225 of method 230, the cybersecurity controller 205 transmits an event which may contain the transaction ID, real-time health hash, and results of the verification, which the service application 206 records at the preferred service provider 208 on the GAIN 204 using the security token.

In embodiments, the device owner configures the device 201 to use the preferred service provider 208 on GAIN 204 to store and manage the recording/logging of the event containing the results of the verification performed by the cybersecurity controller 205. The system 230 is built around a unique locator to enable any service provider 206 that supports the protocols to offer a service supported by the security token (e.g., RvT token).

### Attesting Health of a Device In GAIN

FIG. 2C illustrates an example system (and method) 260 of proving health of a device 201 in an embodiment of the present invention. At step 261 of method 260, a request is made by a third-party auditor from a verification station 255 to audit a transaction of the device 201. At step 262 of method 260, the transaction ID is used to locate the associated recorded event containing real-time health hash and results of the verification for the transaction from the preferred service provider 208 (e.g., blockchain service) on the GAIN 204. The event is then used to verify that real-time tests were actually successfully performed on the state of the cybercontrols at the time of the transaction. At step 263 of method 260, the reference health hash is retrieved by the device 201 from the preferred service provider 208 on the GAIN 204 using the security token. At step 264 of method 260, the device provides the cybercontrol marketplace engine 203 the event and the transaction ID, and the cybercontrols marketplace engine 203 executes a process to calculate an internal cybercontrol hash and external cybercontrol hash from the event. The cybercontrol marketplace engine 203 verifies the calculations match the initial internal and external cybercontrol in the reference health hash. The cybercontrol marketplace engine 203 then generates a transaction report proving the state of the cybercontrols measured at the time of the transaction. The report may be provided to the third-party auditor at the verification station 255.

### Methods of Cybersecurity Controls Verification

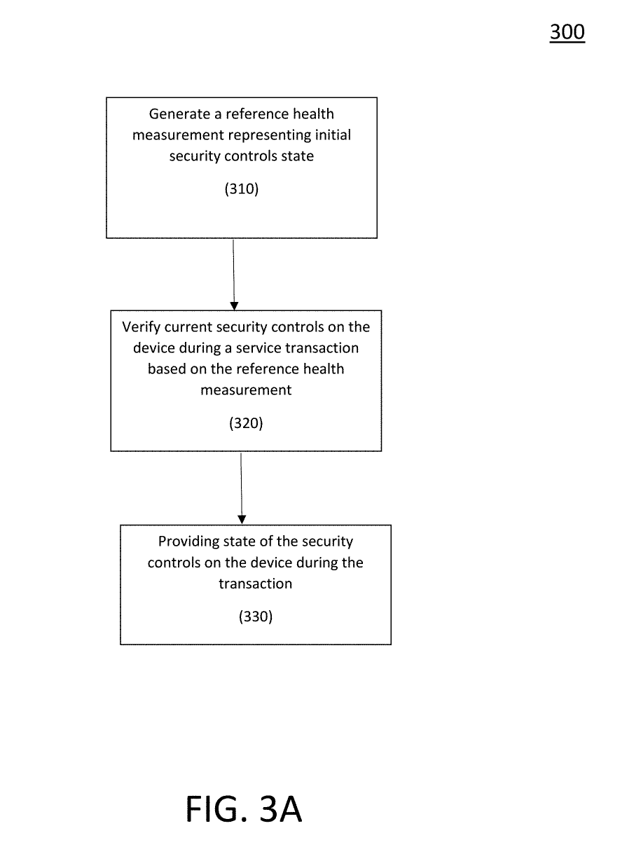

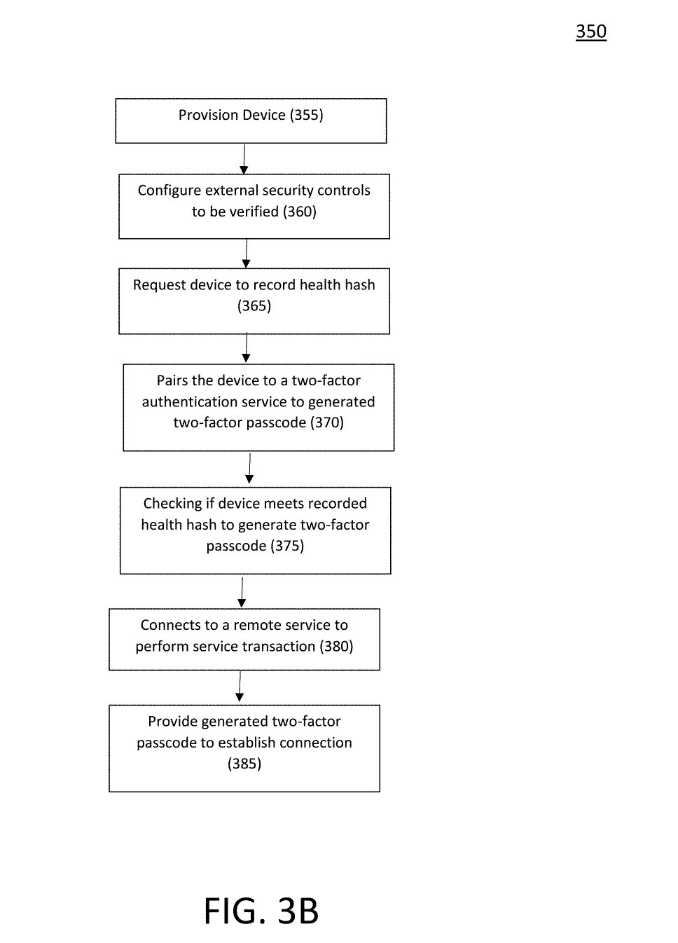

FIG. 3A is an example method of verifying security controls of a device. The method 300 may be performed by the systems 200, 230, and 260 of FIGS. 2A-2C. The method 300 begins at step 310 by generating a reference health measurement representing initial state of security controls on a device. The method (step 310) generates the reference health measurement based on initial internal security controls, initial external security controls, and trusted manufacturer signatures associated with a trusted execution environment (TEE) configured on the device. The method (step 310) records the generated reference health measurement at a network of a trusted service provider using a security token. In embodiments, the trusted service provider includes at least one of: a blockchain, a smart contract, and FinTech. In embodiments, the method 300 (step 310) generates the reference health measurement by the following. First, step 310 verifies the trusted manufacture signatures of the device, and calculates (i) a hash for the internal security controls and (ii) a hash for the external security controls. Second, step 310 combines the internal security controls hash and the external security controls hash into a reference health hash representing the reference health measurement of the device. Using the security token, step 310 seals and records the combined reference health hash at the trusted service provider network, and records the location of the recorded reference health hash at the device.

The method 300 continues at step 320 by, in response to a service transaction, verifying current security controls on the device. Method 300 (step 320) verifies the current security controls based on the recorded reference health measurement using the security token. The method (step 320) records results of the verification for the service transaction at the network of the trusted service provider. In embodiments, step 320 verifies the current security controls on the device by the following. First, step 320, in response to a user initiating the service transaction, creates a transaction identifier for the service transaction. Second, step 320, performs (a) a real-time test of the internal security controls, resulting in a real-time internal controls hash, and (b) a real-time test of the external security controls, resulting in a real-time external controls hash. Third, step 320, combining the internal controls hash and internal controls hash into a real-time health hash. Fourth, using the recorded location and the security token, step 320 retrieves the recorded reference health measurement hash from the trusted service provider network and verifies whether the recorded reference health hash matches the real-time health hash. Fifth, step 320 records the results of the verification, the real-time health hash, and the transaction identifier as an event at the network of the trusted service provider.

The method 300 completes at step 330 by, in response to a device audit, proving state of the security controls on the device during the service transaction. Method 300 (step 330) proves the state based on the recorded verification results and the recorded reference health measurement. In embodiments, step 320 proves the state of the security controls on the device by the following. First, step 330, retrieves the recorded event from the trusted service provider network using the transaction identifier, and retrieves the recorded reference health hash from the trusted service provider network using the recorded location and the security token. Second, step 330, determines an internal security controls hash and an external security controls hash from the real-time health hash in the recorded event. Third, step 330, verifies that (a) the determined internal security control hash matches the internal security controls hash, and (b) the determined external security control hash matches the external security controls hash based on the reference health hash. Fourth, step 330, generates a report proving the verification of security controls of the device during the service transaction.

### System and Method of Assuring Verification of Controls Measurement

In embodiments, the system 260 of FIG. 2C verifies that the controls specified by the owner at the device 201 are measured and are in reference condition on every use. Such verification may be performed by an auditor via a verification station 255 as shown in system 260 of FIG. 2C. Such verification simplifies compliance with regulations that require certain controls to be active prior to connecting to sensitive services such as financial data or healthcare. For example, California Data protection laws require assurance that access credentials have not been lost and devices are encrypted. The system 260 enables the owner to specify that the device 201 can only generate a passcode after verifying that the device generating the code was externally checked by the cybercontrol marketplace engine 203 to meet the reference condition (e.g., pass a Google attestation test). Other conditions could also be scripted into the system such as, “is the device on the local WIFI” or “is the user is still an employee.” The system 260 provides proof these checks where measured as the owner intended.

In an example embodiment, this verification is performed by method 350 of FIG. 3B. The method 350 begins at step 355 by provisioning the device 201 with a two-factor authentication application and a token (e.g., RvT token) wallet. At step 360 of method 350, the owner of the device 201 determines what external controls to be verified by the device 201 and configures those controls. For example, the validation of the Google SafetyNet service may be used to verify if the whole phone's operating system meets Google's attestation tests. The method 350, at step 365, requests the device 201 to record a reference health hash (as described with reference to FIG. 2A) and the owner of the platform funds the wallet with a security token (e.g., RvT) token. The method 350, at step 370, pairs the device 201 to a two-factor authentication (2FA) enabled service. The 2FA enabled service include capabilities that support the FIDO standards and is (or is similar to) the Google Authenticator application (app). The Google Authenticator app performs all the processing for the generation of a one-time passcode within the trust boundary of a device and if the platform supports text user interface (TUI), it is fully utilized. The method 350, at step 375, checks, via the cybercontrol marketplace, engine 23 if the device meets the recorded reference condition (e.g., passes Google attestation tests), and if so, generates, via the 2FA enabled service, a 2FA passcode in the TEE 202 of the device 201. The method 350, at step 380, connects, via the device 201, to a remote service 206 to perform a service transaction, and, at step 385, provides the generated 2FA passcode to successfully establish the connection between the server 206 and the device 205.

### Use of BlockChain for Security Token

In embodiments, the GAIN is a blockchain. A blockchain is a distributed database consisting of a list of records. Each record has a secure timestamp and a cryptographic link to the previous record. The records are called blocks, and the cryptographic links make it easy to read the database and to verify its accuracy, but make it extremely difficult for an attacker to alter or change the order of records. Because of these properties, a blockchain is a machine-readable unalterable historical record, which makes it especially suitable for security applications. The best known blockchain is the Bitcoin blockchain, which uses the immutable historical record to record irreversible monetary transactions. Another well-known blockchain is the Ethereum blockchain. Ethereum uses the blockchain to store smart contracts as well as the data those smart contracts need to operate.

The existence of an unalterable historical record is essential to the functioning of the RvT token used in embodiments of the present invention. When a device is manufactured, its birth certificate is stored on a blockchain. The birth certificate associates to that physical device a health quote, which may include information such as a hash of firmware. If a device is compromised, its real-time health quote changes. An adversary who wishes to hide the compromise would have to rewrite the entire history of all transactions on the blockchain back to the time of manufacture of the device, which virtually impossible. Moreover, if the device is configured to write a health quote to the blockchain regularly, then the blockchain will not only record that the device is compromised but also when it was compromised.

The RvT token is flexible and can store many other types of information in the historical record. For example, a shipping company might use a RvT token in combination with beacons to prove that a piece of cargo was always refrigerated, or always in proper custody. The idea of blockchains goes back at least to the early 1990s, but the first major practical application was Bitcoin, starting in 2009. The calculations (mathematics) are relatively straightforward. The core idea is that of a linked list where each record or block points to the block that precedes it immediately in time. A “pointer” here is a cryptographic hash rather than a memory location. A version of this idea is familiar to many developers as the basic structure in the source control system. Given the blockchain in its entirety, anyone can verify the integrity of the blockchain by iterating over it and computing hashes of all the blocks.

Attestation with Embedded Encryption Keys

In embodiments, systems are built to perform verification of an attestation claim (e.g., health or integrity condition) of a device. One example is verifying whether reference health stored for a device equals real-time health of the device. The systems include the verification capability as logic, but then the underlying device or coupled server needs to be trusted to process the verification logic. In addition, modern servers are encrypting data on the servers and access to this data can typically be freely accessed by administrators of the servers. Embodiments of the present invention use a mixture of attestation and key management to assure that devices that are granted access to server data are only in a known condition the owner of the platform approves. Further, data in a cloud server needs to be encrypted and only processed when a known device in a known condition is connected to the cloud server. This not only assures the simplicity of mobile application access to the data, but also assures that sensitive data of the server is only available when a specific device is connected to the server.

In embodiments of the present invention, the data on a server (e.g., on a cloud platform) is protected by encryption. Only when a device (such as device 201 of FIGS. 2A-2C) is attested and is using keys according to the device's policy is the device's keying material provided to the server to decrypt the data. To perform this verification, the server has its own TEE and combines the device keys with service keys of the server to release the platform data to the device. In this way the data held on the server cannot be consumed or processed without the device present. The server may verify the attestation information of the device to assure the device is working as required.

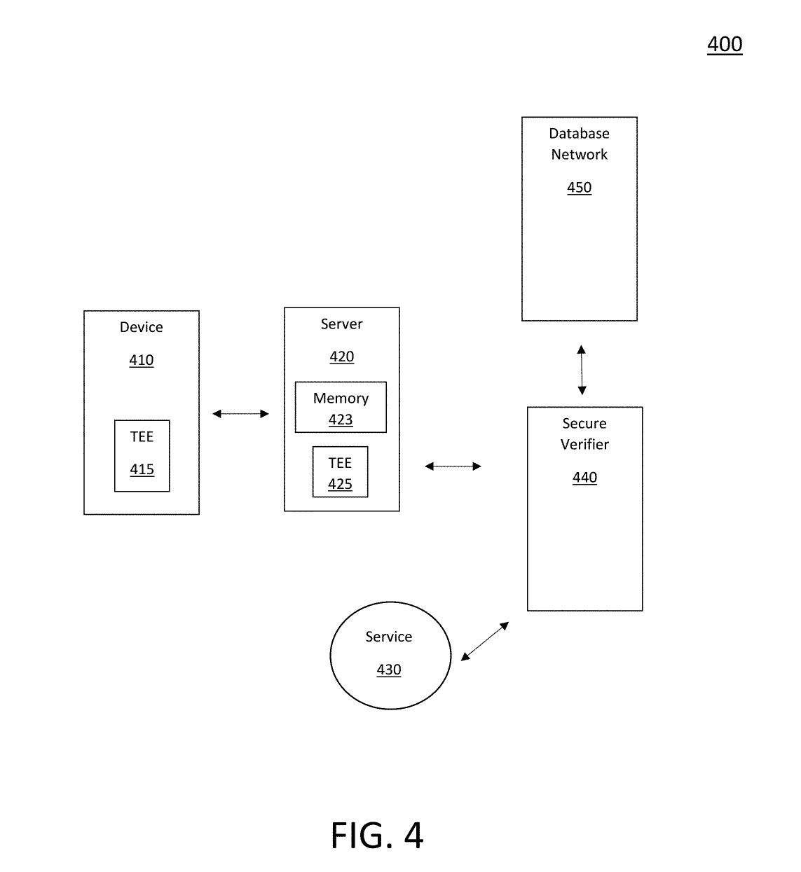

FIG. 4 illustrates a system (and method) 400 that augments existing attestation protocols with the secure release of an encryption key that enables a requesting device to access encrypted data on a server only when the requesting device is in a measured reference condition. The system includes a requesting device 410 with a secure subsystem (TEE, HSM, etc.) 415. The requesting device 410 may be device 201 of FIGS. 2A-2C. The device 410 provides identity information and real-time (health or integrity) measurements to a server 420 also having a secure subsystem (TEE, HSM, etc.) 425. The real-time measurements may be generated in the secure subsystem 415 of the device 410. The server 420, via a service 430, submits this the identify information and real-time measurements to a secure verifier 440, situated either locally or remotely to the server 420, such as in the operating system (OS), the TEE/HSM 415, 425, an executed smart contract, or a remote secure process associated with the server 420 or device 410.

Based on the provided identity information, the secure verifier 440 looks-up and retrieves a measured reference condition of the requesting device in a database network 450, such as a blockchain, along with associated encryption key (which may be encrypted). During an initial state of the device 410, the device 410 (e.g., from the TEE 415) or server 420 (e.g., from the TEE 425) securely stored the encryption keys together with the measured reference condition in database network 450. The encryption key may be delivered to software on the server 420, the TEE/HSM 425, a local smart contract, or another secure process associated with the server 420 or device 410. The secure verifier 440 or server 420 compares the provided real-time measurements to the retrieved measured reference condition. If the measurements match, the secure verifier 440 or server 420 (e.g., in the secure subsystem 425 of the server 420) uses the provided identity information together with the retrieved encryption keys to produce a decryption key. This decryption key is used by the server 420 to fetch secure data stored in secure memory 423 coupled to the server 420, which is returned to the device 410. For example, the server 405 (by the secure subsystem 425) may combine the decryption key with service keys of the server 420 to fetch the secure data from the secure memory 423 of the server.

In embodiments, the secure subsystem 415 or 425 of the device 410 or server 420 may provide internal and external measurements of the state of the device 410 or server 420. These measurements are reduced to a cryptographic hash that can be initially recorded (stored) externally (e.g., in an external database, blockchain, etc.) as reference measurements (hash) in the database network 450. During initial reference measurement storage, the secure subsystem 415 or 425 securely stores encryption keys together with the reference measurements, and a locator is returned and stored at the subsystem 415 or 425 to later locate the reference measurements. Later, the secure subsystem 415 or 425 retrieves a real-time internal and or external measurement of the state of the system and creates a real-time hash of the aggregation of those measurements. The secure subsystem 415 or 425 sends the real-time hash and the stored location of a reference hash to a remote service 430.

The remote service 430 then contacts or uses a validator (secure verifier) 440 that, using the locator, fetches the reference measurements (hash) and the encryption keys. If the real-time hash is equal to the reference hash then the encryption keys are returned to the remote service 430. The secure subsystem 425 of the server 420 uses the returned encryption key to retrieve secure data stored in secure memory 423 at the server 425 and send the data to the device 410. In embodiments, the secure subsystem 425 may combine device and/or service keys with the encryption keys of the server 420, and use the combined keys to retrieve and send the secure data to the device 410.

In embodiments, after using the encryption keys, the remote service 430 logs and returns data to the location in the database network 450 holding the reference hash to record the logging data associated with those encryption keys. In example embodiments, the remote service 430 is a smart contract, and the remote service executes in a trusted execution environment and the remote service executed in a hardware security module (HSM). In example embodiments, the encryption keys are used to unseal critical data for a trusted execution process on the remote service 230. In some example embodiments, a remote service 430 can modify the reference measurements (hash) with attribute or state data that can be returned in the future. In example embodiments, state data can be securely sent to the reference location of the database network 450 via the validator 440 or via the secure subsystem 425. In example embodiments, the state data can be retrieved from the validator 440 and/or directly fetched by the remote service 430. In some embodiments, multiple devices can share the same encryption keys, by registering multiple reference conditions for a single encryption key. Example embodiments grant time-based access to the encryption keys based on the initial access and require additional verification to maintain access assuring a continuous monitoring model.

### Trusted Execution Environment Credentials

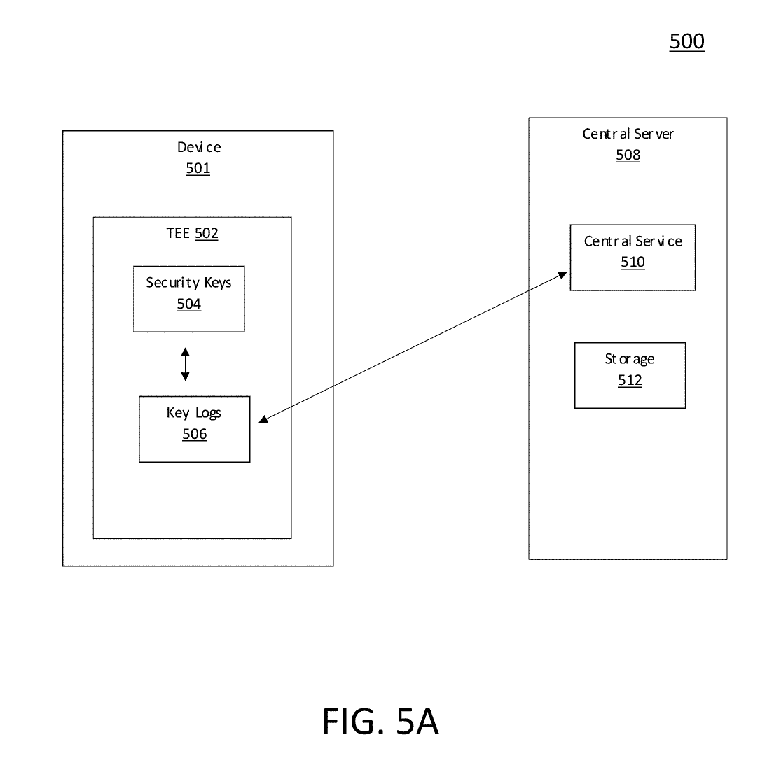

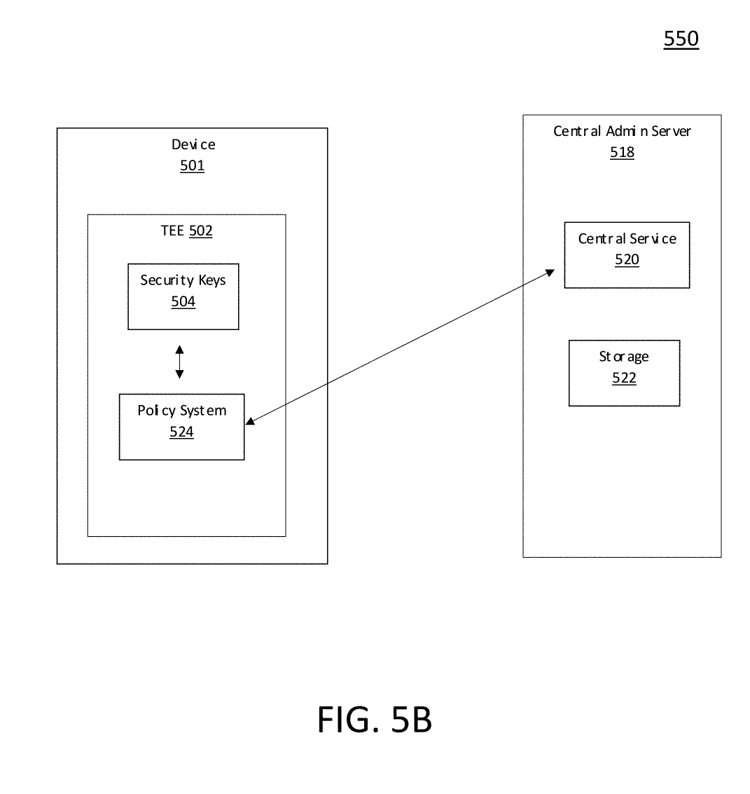

FIG. 5A illustrates a system (and method) 500 that locally logs the use of security keys 504 (e.g., public and private keys associated with blockchain transactions) in the TEE 502 of the device 501 in embodiments of the present invention. The TEE 502 locally accumulates the local logs 506 of the use of the keys 504 and then reports to a central service 510 of a central server or network 508 (e.g., blockchain network), where the logs 506 are stored in storage 512. The local usage of a particular key 504 at the device 201 can require reporting of the log 506 of use for that key 504. That is, after one use or multiple uses of the particular key 504, the key 504 can no longer be used until the log 506 of use of the key 504 has been reported to the central service 510 (and stored in the storage 512). These embodiments include a mechanism where the TEE 502 of the device 501 creates a random number for a log 506 of use of a key 504, and that random number is recorded in storage 512 at the central server 508 as part of recording the log 506 of use of the key 504. The TEE 504 can then communicate with the central service 510 determine (be provided evidence) that a record in storage 512 central server 508 (e.g., a block on the chain) has the random number located in it, assuring the log 506 of use of the respective key 504 has been recorded in storage 512 at the central server 508. Based on the stored use logs 506 of a key 504, the device 501 or other devices can verify if an activity using a key 504 is a trusted activity perform from the device 501, and control the frequency of uses of the key 504.

Embodiments of the present invention provide credentials (policies) held by the TEE 502 that both have rules and report use. Using the credentials, the TEE 502 of a device 501 measures the use of keys 504 at the device 501 in the respective key logs 506 (e.g., private key logs) and reports the use (key logs) to the central service 510. The TEE 502 may block the use of a key 504 until the previous logging of use in a key log 506 has been confirmed internally by the TEE 502. In example embodiments, the TEE 502 further blocks (controls) the key 504 for only being used during specific times of day.

### Proof of a Control

FIG. 5B illustrate a system (and method) 550 for administrating a policy system 524 for device security keys 504 in embodiments of the present invention. In FIG. 5B, the owner of a device 501 grants access control to a central administrative (admin) server 518, via a central service 520, for administration of the policy system 524 for keys 504 within the TEE 502 of the device 501. The central admin server 518 may be a central server or network (e.g., blockchain). The central admin server 518, via the central service 520, controls and logs any changes in a policy in the policy system 524 for a key 504 of the device 501. The central service 520 records the logs in storage 522 at the central admin server 518. By granting control to the central admin server 518, the changes in policy for that key or service 504 can only be performed through the central service 520 of the central admin server 518. This assures that no change in the state of the TEE 502 can be made without the central service 520 logging the changes in the storage 522. The result is that the administrative condition for the device 501 no longer has local control, but can be administrated only by the central admin server 518.

The device 501 can securely register with the central service 520 and exchange authentication key information through the TEE 502. This assures the claiming of administrative control cannot be observed and the admin credentials of the keys 504 remain safe. The TEE policy system 524 can also be recovered in the case that central controls are lost or compromised, but only by resetting the policy system 524 within the TEE 502. The resetting of the policy system 524 within the TEE 502 assures that attestation measurements for the device 501 are no longer the same. In some embodiments, systems of the TEE 502 for attestation of the device 501 may also be integrated within the authentication of the central admin server 518.

### Bidirectional Attestations Using Smart Contract

In embodiments, attestation structure is used to assure (using a smart contract) that two systems are operating as expected with a third-party system logging the result. The smart contract may instead be a cloud service. The smart contract may be configured as a policy that is required to be applied before a security key is used on a client device for performing transactions. The policy may require that to grant the policy, the client device and a server engaging in a transaction are both validated to be in a known (healthy condition) before the key for the transaction can be used to consummate the transaction.

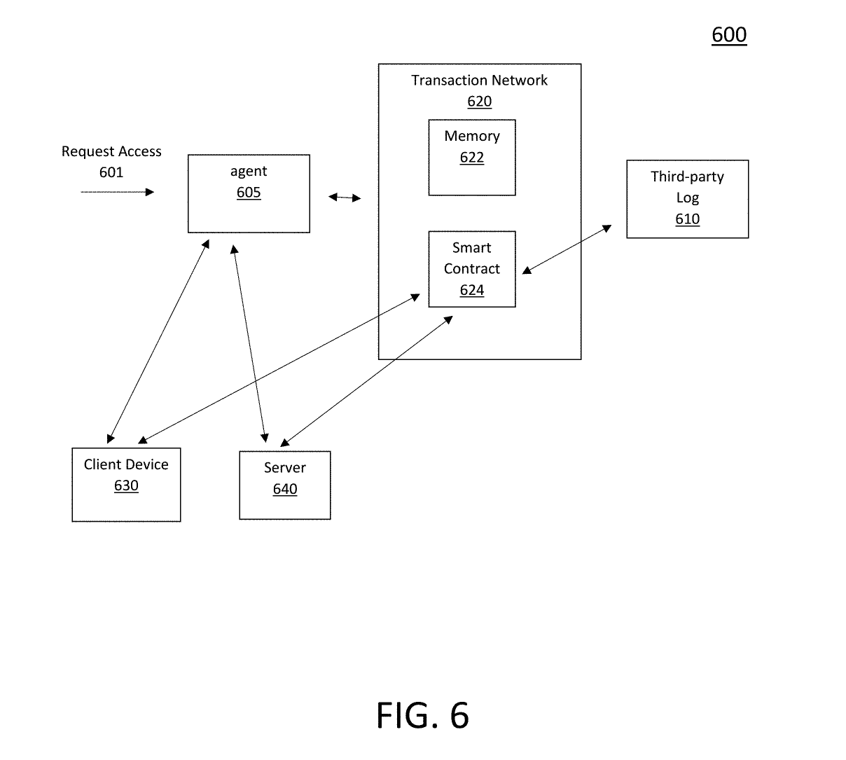

Embodiments provide to a user needed bidirectional attestation of the health and integrity of a system, which includes at least a client device and server. FIG. 6 illustrates a system (and method) 600 for performing bidirectional attestation of a client device 630 and server 640 prior to secure keys of the device 630 and/or server 640 are used to conduct a transaction between the device 630 and server 640. In FIG. 6, the system 600 includes a smart contract 624 that is used to perform the bidirectional attestation. The smart contract 624 is hosted on a transaction network (distribute application model) 620, such as the blockchain. To achieve access to the system 600 configured with the client 630 and server 640, an untrusted agent on an external server (e.g., cloud server) is contacted by the client device 630 and/or server 640 to request access 601. The client device 630 provides device identity, a real-time hash message address, and a reference hash locator. The server 640 configured in a trusted execution environment, like trusted execution technology (TXT), provides an identity real-time hash message address and reference hash locator.

The smart contract 624 is activated with the provided data and an access control challenge token. Using the real-time hash message address of the client device 630, the smart contract 624 sends messages to the client device 630, including real-time hash messages addressed with a nonce. In response to the messages, the client device 630 returns the real-time hash for the client device 630 using the nonce. Using the real-time hash message address of the server 640, the smart contract 624 sends messages to the server 640, including real-time hash messages addressed with the nonce. In response to the messages, the server 640 returns the real-time hash for the server 640 using the nonce. The nonce is hashed with the real-time integrity hash. The smart contract 624 uses the reference hash locator for the client device 630 to retrieve the reference hash for the client device 630, and compares the retrieved referenced hash to the retrieved real-time hash for the client device 630. The smart contract 624 uses the reference hash locator for the server 640 to retrieve the reference hash for the server 640, and compares the retrieved referenced hash to the retrieved real-time hash for the server 640. If the comparisons for the client device 630 and server 640 both match, then, using the challenge token, the smart contract retrieves and responds with the correct response to an access challenge issued. Based on the correct response, the requested access is granted and keys of the client device 630 and/or server 640 can now be used to perform the transaction. The smart contract 624 also logs an event independently of the service to a third-party log 610.

Multi-Factor Authentication with Integrated and External Attestation

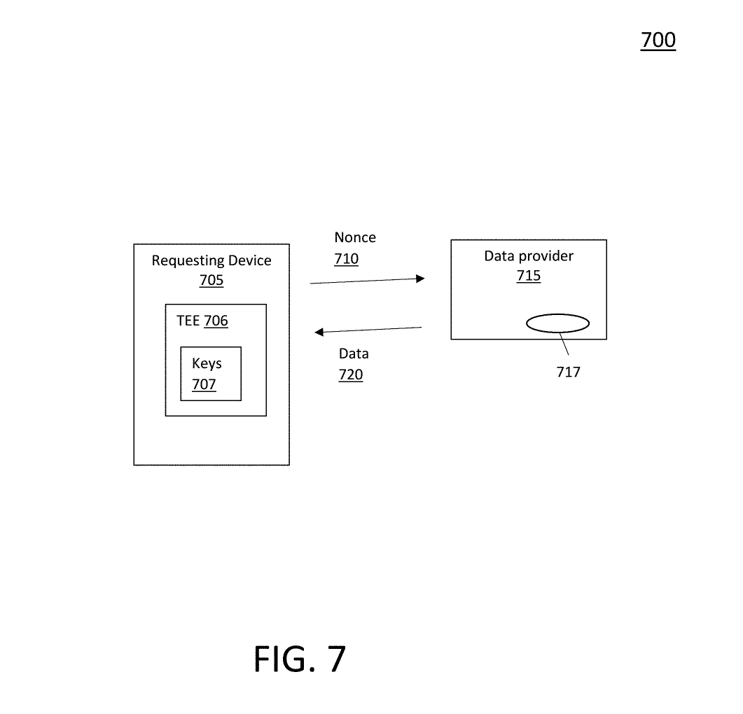

This model is illustrated by the system 700 of FIG. 7. The system 700 includes a requesting device 705 (with a TEE 706) that produces a nonce 710, which is sent to an external authentication or data provider 715. The requesting device 705 and data provider 715 are paired systems that had previously been registered to enable the sharing of secure authentication/communication keys. The external data provider 715 then performs a function 717 and uses the nonce 710 to return the data results 720 of the function 717 which can be used by the TEE 706 requesting device 705 as part of authentication. The returned data 720 can be used by the TEE 706 to ultimately provide or calculate the shared authentication keys for the pair requesting device 705 and data provider 715.

Embodiments of system 700 of FIG. 7 use the returned data 720 for multi-factor authentication using TEE 706 and TUI with integrated attestation and external attestation. These embodiments use the TEE 706 of the requesting device 705 to log the use of the second factor (e.g., returned data or token 720), so that any use of a token by malware is detected using unrelated systems to notify the user that their 2FA was used. These embodiments may further use the TEE 706 to require a third out-of-band authentication to complete a transaction (e.g., in which the user called for a voice print). These embodiments then use the TEE 706 to record the usage of the second factor that is calculated offline (e.g. by function 717 of the data provider 715), and report and record the data 720 as a provable time stamped event stored in a transaction networks, such as a blockchain. These embodiments lock the use of the second factor authentication using the TEE 706, such that a security token is provided that locks the requesting device 705 for a prescribed period of time or until an unlock is received. In these embodiments, a process of the TEE 706 then system wipe the second factor from the TEE 706 of the device 705.

Transactions in Compliance with Policy

Embodiments of the present invention also verify that service transactions (purchases) are in compliance with policies on a computing device. The systems/methods of these embodiments may, prior to the approval of an aggregated financial transaction, verify a business process to assure the individual items (itemized data) being purchased are in compliance with the policy. The systems/methods may provide the itemized data from a point-of-sale system, where the itemized data is signed and/or encrypted based on keys that are controlled or partially controlled by a user's device. The systems/methods may allow partial transactions for the itemized data, if only a portion of the itemized data is permissioned by the policies. The systems/methods may also divide and complete a transaction by two separate payment solutions or separate transactions of the itemized data. The systems/methods may apply the policies locally by the computing device with a TEE prior to the submission of the transaction to a transaction processing system.

The systems/methods may integrate local user identity and delivery of the assured transaction details to a central policy enforcement point (system). The transaction details may be locally encrypted and signed prior to delivery for processing, and the transaction details may include categorization for testing against the policies. The receipts of the transaction may include metadata to help the user manage their historical purchases. The transaction receipts may also include product supply chain details, including signature data to assure the items purchased have clear supply chain history. The systems/methods may individually protect the transaction receipts by recording the receipts in block chain technology to assure an auditable record of purchase. The systems/methods may integrate multiple sources of funds to be used in a single transaction. The systems/methods may also enable the user to permission third-parties to have access to all or a portion of the receipt data that has been collected/recorded (e.g., on a blockchain). The systems/methods may provide limited time access to transaction records and/or enable the user to control private keys that release transaction records. The systems/methods may offer promotions based on historical transaction records and/or policy requirements and transaction records.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A computer-implemented method of verifying security controls of a device, the method comprising:
generating a reference health measurement representing initial state of security controls on a device, wherein recording the reference health measurement at a network of a trusted service provider using a security token;
in response to a service transaction, verifying current security controls on the device based on the recorded reference health measurement using the security token, wherein recording results of the verification for the service transaction at the network of the trusted service provider; and
in response to a device audit, proving state of the security controls on the device during the service transaction based on the recorded verification results and the recorded reference health measurement.

2. The method of claim 1, wherein the trusted service provider is at least one of: Blockchain, Smart Contracts, and FinTech.

3. The method of claim 1, wherein the generating the reference health measurement is based on initial internal security controls, initial external security controls, and trusted manufacturer signatures associated with a trusted execution environment (TEE) configured on the device.

4. The method of claim 3, wherein the generating the reference health measurement further comprises:
verifying the trusted manufacture signatures;
calculating (i) a hash for the internal security controls and (ii) a hash for the external security controls;
combining the internal security controls hash and the external security controls hash into a reference health hash representing the reference health measurement of the device; and
using the security token, sealing and recording the combined reference health hash at the trusted service provider network, wherein recording the location of the recorded reference health hash at the device.

5. The method of claim 1, wherein the verifying current security controls on the device further comprises:
in response to a user initiating the service transaction, creating a transaction identifier for the service transaction;
performing: (a) a real-time test of the internal security controls, resulting in a real-time internal controls hash, and (b) a real-time test of the external security controls, resulting in a real-time external controls hash;
combining the internal controls hash and internal controls hash into a real-time health hash;
using the recorded location and the security token, retrieving the recorded reference health measurement hash from the trusted service provider network, wherein verifying whether the recorded reference health hash matches the real-time health hash; and
recording the results of the verification, the real-time health hash, and the transaction identifier as an event at the network of the trusted service provider.

6. The method of claim 1, wherein the proving state of the security controls further comprises:
retrieving the recorded event from the trusted service provider network using the transaction identifier;
retrieving the recorded reference health hash from the trusted service provider network using the recorded location and the security token;
determining an internal security controls hash and an external security controls hash from the real-time health hash in the recorded event;
verifying that (a) the determined internal security control hash matches the internal security controls hash and (b) the determined external security control hash matches the external security controls hash based on the reference health hash; and
generating a report proving the verification of security controls of the device during the service transaction.

7. The method of claim 1, wherein the service transaction is a financial transaction, and applying compliance policies locally, including encrypting, signing, and recording receipts of the service transaction, at the device to partially control the financial transaction at the device prior to the submission of the financial transaction to a transaction processing system

8. The method of claim 1, further comprising performing bidirectional attestation of the health and integrity of a system by:
providing by the device to a smart contract a first set of data including: device identity, a real-time hash message address, and a reference hash locator, wherein the smart contract is hosted on a distribute app model using the blockchain and accessed by an untrusted agent on a cloud server;
providing by a service provider server to the smart contract a second set of data including: an identity real-time hash message address and reference hash locator;
activating a smart contract with the first and second sets of data and an access control challenge token, the activating sending messages to both the device and the server;
using the reference hash locators to retrieve references hashes for the device and the server; and
comparing, by the smart contract, the real-time hashes returns in respond to the sent messages and reference hashes for the client device and the server, and if the hashes match, the smart contract responds with the correct response to the control challenge, thereby granting access to the service transaction.

9. The method of claim 1, wherein the TEE configured on the device uses second factor authentication (2FA) or multi factor authentication (MFA) and logs the device's 2FA or MFA as a provable time stamped event in the blockchain, such that if use of the security token associated with the 2FA or MFA is detected in unrelated systems, the TEE notifies the user of the use and locks the device.

10. The method of claim 1, wherein the TEE configured on the device:
measures and logs use of authentication keys at the device, the logs being sent to a central service for recording and accessing; and
blocks use of the authentication keys at the device until at least one of: the authentication keys are logged at the central service, the logged use is confirmed internally by the TEE, and the use is during specific times of day.

11. The method of claim 1, wherein integrity of the device is further controlled by:
performing a BIOS integrity control test that produces a BIOS integrity token for the device, the BIOS integrity token asserted to third-party services to assure BIOS integrity test were completed on devices executing the third-party services.

12. The method of claim 1, wherein:
performing verification that the device meeting the recorded reference health measurement; and
only enabling generation of a two-factor passcode to perform transactions from the device if the verification is successful.

13. The method of claim 1, wherein:
receiving a request from the device to a server to access encrypted data stored at the server;
in response to the request, performing, via a secure verifier, verification that current health measurements of the device meet the recorded reference health measurement for the device; and
based on meeting the recorded reference health measurement, releasing encryption information recorded associated to the reference health measurement; and
using the released encryption information to decrypt and return to the device the encrypted data stored at the server.

14. The method of claim 1, further comprising communicating with a central service that administers a policy system that controls authentication keys and services on the device, the central service controlling and logging changes in policies for an authentication key or service of the device.

15. The method of claim 1, wherein the TEE configured on the device provides multi-factor authentication (MFA) by:
generating, by the device, a nonce that is sent to a paired data provider enabled to share authentication keys with the device;
in response the data provider, performing an authentication function and returning the data results to the device using the nonce;
using the data results to calculate the shared authentication keys for the paired device and data provider to provide a second authentication factor for the pairing.

16. A computer system for verifying security controls of a device, the system comprising:
a cybercontrol marketplace engine configured to generate a reference health measurement representing initial state of security controls on a device, wherein recording the reference health measurement at a network of a trusted service provider using a security token;
a cybersecurity controller configured to, in response to a service transaction, verify current security controls on the device based on the recorded reference health measurement using the security token, wherein recording results of the verification for the service transaction at the network of the trusted service provider; and
the cybercontrol marketplace engine further configured to, in response to a device audit, prove state of the security controls on the device during the service transaction based on the recorded verification results and the recorded reference health measurement.

17. The system of claim 16, wherein the trusted service provider is at least one of: Blockchain, Smart Contracts, and FinTech.

18. The system of claim 16, wherein the cybercontrol marketplace engine is configured to generate the reference health measurement based on initial internal security controls, initial external security controls, and trusted manufacturer signatures associated with the trusted execution environment (TEE) configured on the device.

19. The system of claim 16, wherein generating the reference health measurement further comprises:
the cybercontrol marketplace engine is configured to:
verify the trusted manufacture signatures;
calculate (i) a hash for the internal security controls and (ii) a hash for the external security controls; and
combine the internal security controls hash and the external security controls hash into a reference health hash representing the reference health measurement of the device; and
the device is configured to:
using the security token, seal and record the combined reference health hash at the trusted service provider network, wherein recording the location of the recorded reference health hash at the device.

20. The system of claim 16, wherein the verifying current security controls on the device further comprises:
the cybercontrol marketplace engine, in communication with the device, configured to:
in response to a user initiating the service transaction on the device, create a transaction identifier for the service transaction;
perform (a) a real-time test of the internal security controls, resulting in a real-time internal controls hash, and (b) a real-time test of the external security controls, resulting in a real-time external controls hash;
combine the internal controls hash and internal controls hash into a real-time health hash; and
the cybersecurity controller, in communication with the device, configured to:
using the recorded location and the security token, retrieve the recorded reference health measurement hash from the trusted service provider network, wherein verifying whether the recorded reference health hash matches the real-time health hash; and
record the results of the verification, the real-time health hash, and the transaction identifier as an event at the network of the trusted service provider.

21. The system of claim 16, wherein the proving state of the security controls further comprises:
the device configured to:
retrieve the recorded event from the trusted service provider network using the transaction identifier and the security token;
retrieve the recorded reference health hash from the trusted service provider network using the recorded location and the security token; and
the cybercontrol marketplace engine, in communication with the device, configured to:
determine an internal security controls hash and an external security controls hash from the real-time health hash in the recorded event;
verify that (a) the determined internal security control hash matches the internal security controls hash and (b) the determined external security control hash matches the external security controls hash based on the reference health hash; and
generate a report proving the verification of security controls of the device during the service transaction.

22. The system of claim 16, wherein the service transaction is a financial transaction, and applying compliance policies locally, including encrypting, signing, and recording receipts of the service transaction, at the device to partially control the financial transaction at the device prior to the submission of the financial transaction to a transaction processing system

23. The system of claim 16, further comprising performing bidirectional attestation of the health and integrity of the system by:
providing by the client device to a smart contract a first set of data including: device identity, a real-time hash message address, and a reference hash locator, wherein the smart contract is hosted on a distribute app model using the blockchain and accessed by an untrusted agent on a cloud server;
providing by a service provider server to the smart contract a second set of data including: an identity real-time hash message address and reference hash locator;
activating a smart contract with the first and second sets of data and an access control challenge token, the activating sending messages to both the device and the service;
using the reference hash locators to retrieve references hashes for the device and server; and
comparing, by the smart contract, the real-time hashes returns in respond to the sent messages and reference hashes for the client device and the server, and if the hashes match, the smart contract responds with the correct response to the control challenge, thereby granting access to the service transaction.

24. The system of claim 16, wherein the TEE configured on the device uses second factor authentication (2FA) or multi factor authentication (MFA) and logs the device's 2FA or MFA as a provable time stamped event in the blockchain, such that if use of the security token associated with the 2FA or MFA is detected in unrelated systems, the TEE notifies the user of the use and locks the device.

25. The system of claim 16, wherein the TEE configured on the device:
measures and logs use of authentication keys at the device, the logs being sent to a central service for recording and accessing; and
blocks use of the authentication keys at the device until at least one of: the authentication keys are logged at the central service, the logged use is confirmed internally by the TEE, and the use is during specific times of day.

26. The system of claim 16, wherein integrity of the device is further controlled by:
performing a BIOS integrity control test that produces a BIOS integrity token for the device, the BIOS integrity token asserted to third-party services to assure BIOS integrity test were completed on devices executing the third-party services.

27. The system of claim 16, wherein the cybercontrol marketplace engine is further configured to:
perform verification that the device meets the recorded reference health measurement; and
only enable generation of a two-factor passcode to perform transactions from the device if the verification is successful.

28. The system of claim 16, wherein the cybercontrol marketplace engine is further configured to:
receive a request from the device to a server to access encrypted data stored at the server;
in response to the request, perform, via a secure verifier, verification that current health measurements of the device meet the recorded reference health measurement for the device; and
based on meeting the recorded reference health measurement, release encryption information recorded associated to the reference health measurement; and
using the released encryption information to decrypt and return to the device the encrypted data stored at the server.

29. The system of claim 16, wherein the cybercontrol marketplace engine is further configured to: communicate with central service that administers a policy system that controls authentication keys and services on the device, the central service controls and logs changes in policies for an authentication key or service of the device.

30. The system of claim 16, wherein the TEE configured on the device provides multi-factor authentication (MFA) by:
generating, by the device, a nonce that is sent to a paired data provider enabled to share authentication keys with the device;
in response the data provider, performing an authentication function and returning the data results to the device using the nonce;
using the data results to calculate the shared authentication keys for the paired device and data provider to provide a second authentication factor for the pairing.
